(19) United States
(12) Patent Application Publication
(10) Pub. No.: US 2015/0073902 A1
(43) Pub. Date: Mar. 12, 2015

(54) Financial Transaction Analytics

(71) Applicant: International Business Machines Corporation, Armonk, NY (US)

(72) Inventors: Soujanya Soni, New Delhi (IN); Vishal S. Batra, New Delhi (IN); Mukesh K. Mohania, New Delhi (IN)

(73) Assignee: International Business Machines Corporation, Armonk, NY (US)

(21) Appl. No.: 14/024,822

(22) Filed: Sep. 12, 2013

(51) Int. Cl. G06Q 30/02

(52) U.S. Cl. CPC G06Q 30/0255; G06Q 30/0261; G06Q 30/0269
USPC 705/14.53

(57) ABSTRACT

Methods, systems, and articles of manufacture for financial transaction analytics are provided herein. A method includes generating a profile of a customer, the customer profile comprising multiple commercial-related parameters pertaining to the customer based at least on past transaction information of the customer; determining the identity of a merchant from a message pertaining to a transaction of the customer; determining location information of the customer from the message pertaining to the customer transaction; and generating at least one commercial offer personalized for the customer based on (i) the customer profile, (ii) the merchant identified from the message, and (iii) the customer location determined from the message.

### FIELD OF THE INVENTION

Embodiments of the invention generally relate to information technology, and, more particularly, to analytics.

### BACKGROUND

Banking transaction messages and alerts, such as transaction alerts sent through short message service (SMS) and email, can carry insight about transaction location and behavior. However, such information is not available in a data warehouse (DWH), and location-based recommendations cannot be identified using such information in existing approaches. Accordingly, a need exists for real-time analytics of such information to provide additional capability to identify location-specific offers for customers to increase sales and/or payments.

### SUMMARY

In one aspect of the present invention, techniques for financial transaction analytics are provided. An exemplary computer-implemented method can include steps of generating a profile of a customer, the customer profile comprising multiple commercial-related parameters pertaining to the customer based at least on past transaction information of the customer; determining the identity of a merchant from a message pertaining to a transaction of the customer; determining location information of the customer from the message pertaining to the customer transaction; and generating at least one commercial offer personalized for the customer based on (i) the customer profile, (ii) the merchant identified from the message, and (iii) the customer location determined from the message.

In another aspect of the invention, an exemplary computer-implemented method can include steps of determining merchant context information from a message pertaining to a customer transaction; determining transaction context information from the message pertaining to the customer transaction; annotating the message with said merchant context information and said transaction context information; applying one or more rules to the annotated message, wherein said one or more rules correspond to one or more conditions associated with a set of commercial offers; and identifying at least one of the set of commercial offers to submit to the customer based on said application of the one or more rules to the annotated message.

Another aspect of the invention or elements thereof can be implemented in the form of an article of manufacture tangibly embodying computer readable instructions which, when implemented, cause a computer to carry out a plurality of method steps, as described herein. Furthermore, another aspect of the invention or elements thereof can be implemented in the form of an apparatus including a memory and at least one processor that is coupled to the memory and configured to perform noted method steps. Yet further, another aspect of the invention or elements thereof can be implemented in the form of means for carrying out the method steps described herein, or elements thereof; the means can include hardware module(s) or a combination of hardware and software modules, wherein the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a block diagram illustrating an example embodiment, according to an aspect of the invention;

FIG. 2 is a flow diagram illustrating techniques according to an embodiment of the invention;

FIG. 3 is a diagram illustrating search repositories, according to an embodiment of the invention;

FIG. 4 is a block diagram illustrating an example embodiment, according to an aspect of the invention;

FIG. 5 is a flow diagram illustrating techniques according to an embodiment of the invention; and

FIG. 6 is a system diagram of an exemplary computer system on which at least one embodiment of the invention can be implemented.

### DETAILED DESCRIPTION

As described herein, an aspect of the present invention includes techniques for financial transaction analytics. At least one embodiment of the invention includes real-time analytics of transaction alerts sent to customers via SMS. Such analytics, as further described herein, can include extracting merchant details such as city, date and time of past user/customer transactions with a given merchant, etc. Additionally, analytics encompassed in one or more embodiments of the invention can include inferring the location of a merchant as well as a merchant category. Further, such analytics can include analyzing transaction behavior to identify relevant location-based offers for a customer in real-time, to build a customer transaction behavior profile, etc.

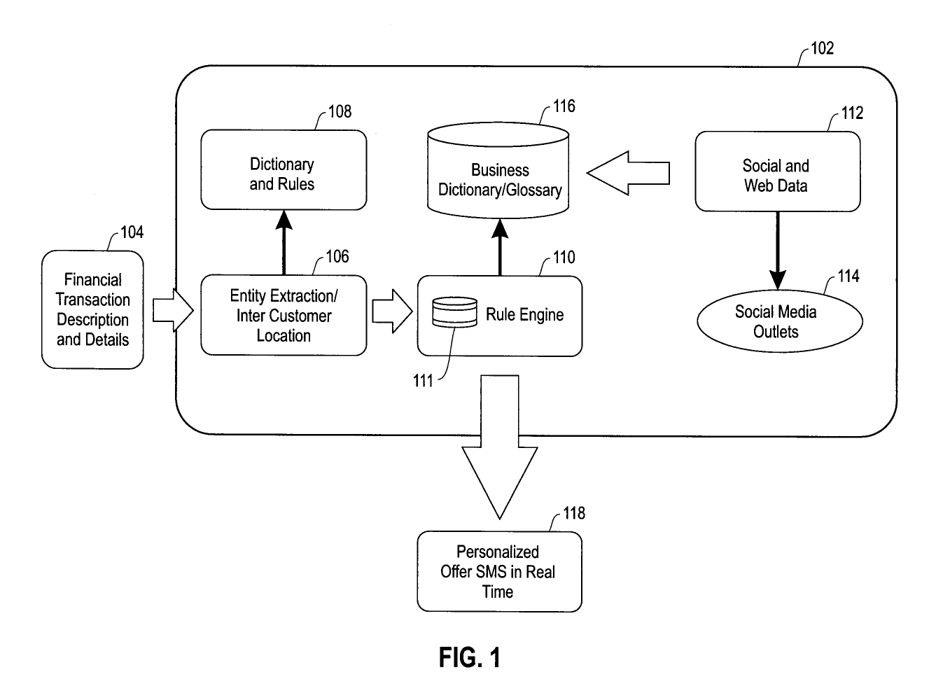

FIG. 1 is a block diagram illustrating an example embodiment, according to an aspect of the invention. By way of illustration, FIG. 1 depicts an analytics component 102, which receives financial transaction description and details 104. Within the analytics component 102, extraction module 106 extracts the entity identity and infers the customer location from the financial transaction description and details 104. The extraction module 106 subsequently provides input to a dictionary and rules module 108 as well as provides input to rule engine 110. Module 108 is a repository that carries and/or maintains dictionary and look-up data and rules. The data and rules are utilized by entity extraction module 106 to extract relevant entities from transaction data.

The rule engine 110 interacts with a business dictionary and/or glossary database 116, which receives input from a social and web data module 112, which analyzes one or more social media outlet components 114 for entity profile enrichment. As further detailed herein, at least one embodiment of the invention includes building a transaction behavior profile of a customer and a merchant for predictive analytics to improve subsequent offer relevance for the customer.

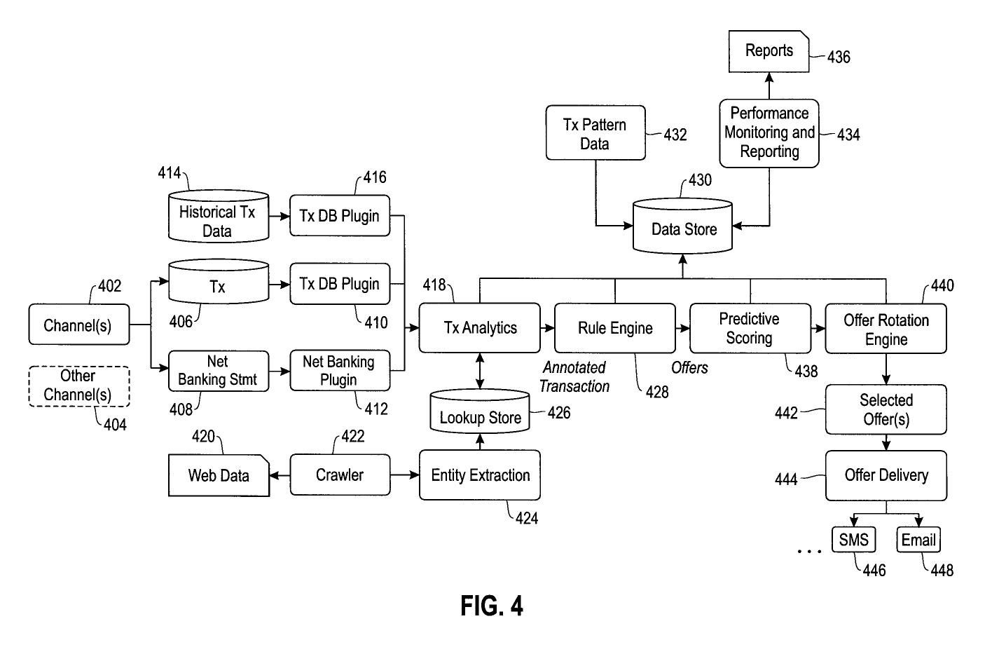

Accordingly, the rule engine 110 outputs a personalized offer 118 in real-time directly to the relevant customer. The offer can be in the form of, for example, SMS, email, or any channel that is within the customer's capabilities. In at least one embodiment of the invention, the offer can be sent separately from a banking SMS alert on channels such as SMS, email, etc., and can also be embedded on channels such as net banking, a branch office application, etc. along with details of the relevant transaction. In at least one embodiment of the invention, the rule engine 110 identifies one or more offers from the transaction data, annotations added to the transaction information from the business dictionary database 116 and the social and web data module 112, historical transaction data, customer data available in customer relationship management (CRM), and rules configured in rules database 111 within the rule engine 110. The one or more offers can also be based in part on the inferred location and transaction information via module 106. Additional and/or related detail is provided below in connection with the description of FIG. 4.

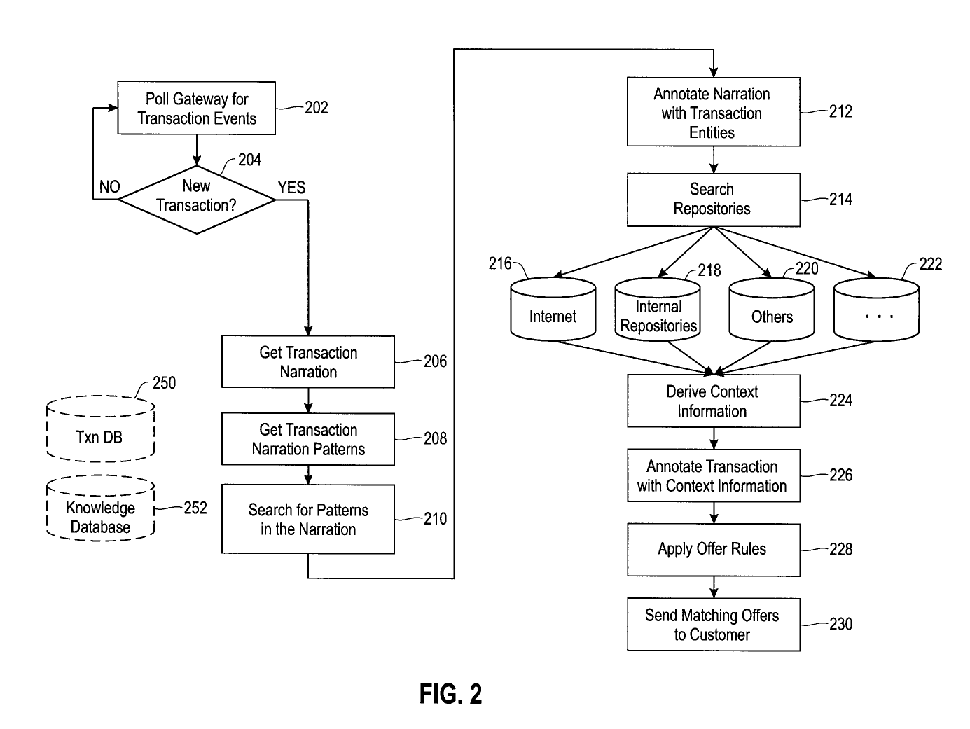

FIG. 2 is a flow diagram illustrating techniques according to an embodiment of the invention. Step 202 includes polling a gateway for transaction events, and step 204 includes determining if there is a new transaction. If no (that is, there is not a new transaction), the flow returns to step 202. If yes (that is, there is a new transaction), the flow continues to step 206, which includes obtaining a transaction narration (that is, a description of the transaction). Additionally, step 208 includes obtaining transaction narration patterns, and step 210 includes searching for patterns in the narration.

In at least one embodiment of the invention, steps 206, 208 and 210 can include the use of a transaction database 250 and a knowledge database 252. Transaction data and corresponding annotations are stored in the incremental transaction database 250, which is analyzed offline to detect transaction patterns per customer, per merchant, etc. The insights are used in identifying offers for future transactions made by the customer and/or at that merchant store, etc.

Step 212 includes annotating the narration with transaction entities. As such, step 214 includes searching repositories such as an internet database 216, one or more internal repositories 218, as well as one or more other databases 220-222. Step 224 includes deriving context information, and step 226 includes annotating the transaction narration with the derived context information. Step 228 includes applying offer rules to the annotated transaction narration, and step 230 includes sending any offers that match the applied rules to the relevant customer. Rules are configured against the transaction narrations and annotations added thereto. Also, a rule can include a nested expression for annotations and their values.

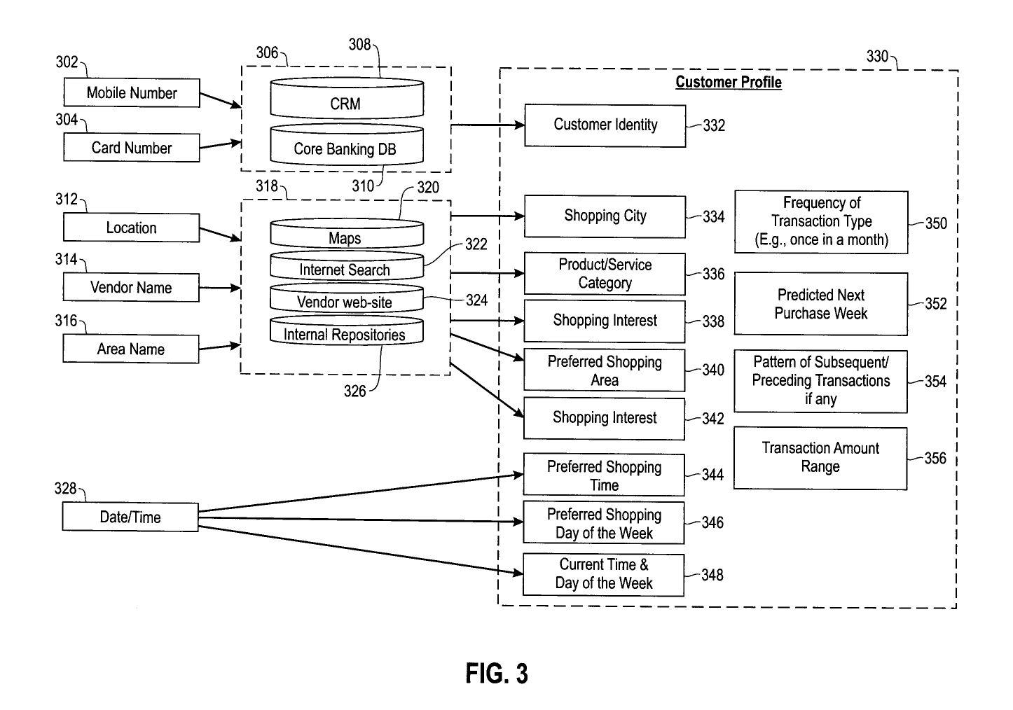

As noted, a sample transaction message (including an offer, for example) to a customer can include annotations such as the mobile number of the user/customer, the credit card number of the user/customer, a transaction amount range, the location of the transaction, the vendor name, the area name, the date and/or time of the transaction, and identification of a patterned transaction occurrence (such as, monthly, weekly, etc.). Such annotations can be derived from various search repositories, as stated above in connection with FIG. 2 as well as further described in connection with FIG. 3.

FIG. 3 is a diagram illustrating search repositories, according to an embodiment of the invention. By way of illustration, FIG. 3 depicts customer information such as a mobile (telephone) number 302 and a credit (or debit) card number 304, which are provided to a customer module 306 which includes a customer relationship management (CRM) database 308 as well as a core banking database 310. As detailed herein, customer information is stored in the CRM database 308 and can be used in analytics and for identifying relevant offers for the customer. The customer module 306 can additionally provide such information as input to a customer profile component 330, specifically to a customer identity module 332 within the customer profile component 330.

Additionally, FIG. 3 depicts commercial information such as location of a vendor 312, name of a vendor 314 and an area of a vendor 316. As used herein, “location” refers to the physical address of the vendor and “area” refers to the merchant category (for example, electronics, apparel, grocery, etc.). Such commercial information is provided to a repository module 318, which includes a map database 320, an internet search database 322, a vendor website database 324 and one or more internal repositories 326.

Additionally, the repository module 318 leverages the noted commercial information and provides input to the customer profile component 330. Within the customer profile component 330, the leveraged commercial information provided by the repository module 318 can update components pertaining to information such as shopping city of the customer 334, product and/or service categories 336, shopping interests 338 and 342, and preferred shopping area(s) 340. Such patterns can be detected from historical data.

Further, FIG. 3 depicts temporal information such as date and/or time 328, which can be provided as input to the customer profile component 330. Within the customer profile component 330, the temporal information 328 can update components pertaining to information such as preferred shopping time(s) of the customer 344, preferred shopping day(s) of the week for the customer 346 and the current time and day of the week 348. Such patterns can also be detected from historical data.

Based on the provided inputs, the customer profile component 330 can additionally generate components pertaining to information such as frequency of a transaction type 350 (for example, once a month, every week, etc.), prediction of a subsequent purchase 352, patterns of ongoing and/or preceding transactions 354, as well as a transaction amount range 356. In at least one embodiment of the invention, transactions, along with additional annotations, are captured and stored, and queries and statistical analysis software products are run on the transaction data to detect patterns.

Additionally, in at least one embodiment of the invention, rules can be formulated based on the information in the search repositories. For example, such rules can detail circumstances for the time and/or day certain types of offers are to be sent to a user/customer (based on customer preferences and/or related customer or commercial information).

FIG. 4 is a block diagram illustrating an example embodiment, according to an aspect of the invention. By way of illustration, FIG. 4 depicts transaction information being obtained via a primary channel 402 and/or other channels 404. The transaction information can be stored in a transaction database 406 via a transaction database plug-in 410 and/or can be utilized to generate a net banking statement 408 via a net banking plug-in 412. Such transaction data can also be combined with historical transaction data (maintained in historical transaction database 414 and accessed via a transaction database plug-in 416) and provided to a transaction analytics component 418.

As also depicted in FIG. 4, a crawler component 422 can process web data 420 to identify and provide relevant data pertaining to an entity to an entity extraction module 424, which extracts entity information and provides such information to a look-up database 426. The transaction analytics component 418 interacts with the look-up database 426 to derive entity information relevant to the given transaction, and subsequently annotates the transaction information and provides the annotated transaction to the rule engine 428. The rule engine 428, based on rules maintained therein, analyzes the annotated transaction and determines one or more customer offers relevant to the annotated transaction. A predictive scoring module 438 analyzes the one or more customer offers and provides input to an offer rotation engine 440, which selects at least one offer 442 of the one or more offers based on the scoring input. Subsequently, an offer delivery module 444 delivers the selected offer(s) to the given customer via one or more channels such as SMS 446, email 448, etc.

Additionally, as depicted in FIG. 4, the transaction analytics component 418, the rule engine 428, the predictive scoring module 438, and the offer rotation engine 440 each provide input to a data store 430. Further, the data store 430 is accessed by a transaction pattern data module 432, which determines one or more patterns based on the stored data in component 430. Also, the data store 430 is accessed by a performance monitoring and reporting module 434, which generates reports 436 based on the stored data in component 430.

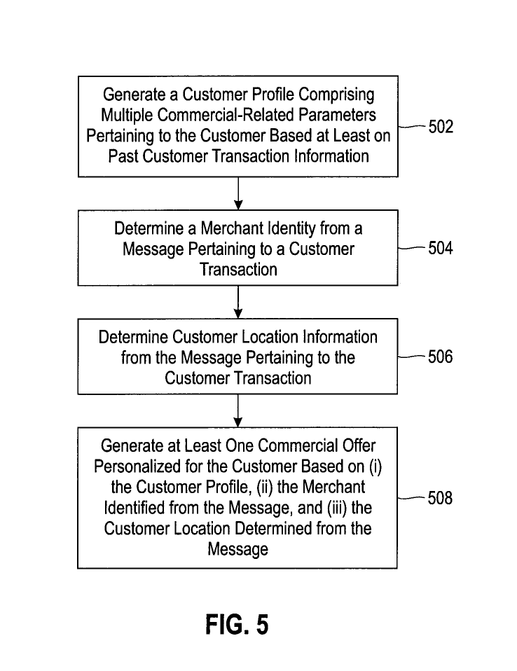

FIG. 5 is a flow diagram illustrating techniques according to an embodiment of the invention. Step 502 includes generating a customer profile comprising multiple commercial-related parameters pertaining to the customer based at least on past customer transaction information. As detailed herein, generating a customer profile can include deriving information pertaining to the customer from one or more social media sources.

Step 504 includes determining a merchant identity from a message pertaining to a customer transaction. Step 506 includes determining customer location information from the message pertaining to the customer transaction. The message can include, for example, a banking message intended for the customer pertaining to the customer transaction. Additionally, the message, as detailed herein, can include an SMS message.

Step 508 includes generating at least one commercial offer personalized for the customer based on (i) the customer profile, (ii) the merchant identified from the message, and (iii) the customer location determined from the message. As described herein, at least one embodiment of the invention includes carrying out each of the steps of FIG. 5 in real-time.

The techniques depicted in FIG. 5 can additionally include determining location of the merchant from the message pertaining to the customer transaction. In such an embodiment of the invention, generating a commercial offer personalized for the customer can be further based on the location of the merchant determined from the message. Additionally, at least one embodiment of the invention includes determining a merchant category associated with the merchant from the message pertaining to the customer transaction. In such an embodiment of the invention, generating a commercial offer personalized for the customer can be further based on the merchant category of the merchant determined from the message.

Also, the techniques depicted in FIG. 5 can include determining temporal information associated with the customer transaction from the message pertaining to the customer transaction. Accordingly, in such an embodiment of the invention, generating a commercial offer personalized for the customer can be further based on the temporal information associated with the customer transaction.

At least one embodiment of the invention can further include storing the message in a database, as well as determining one or more customer transaction patterns (for example, frequency of a given transaction type) from information stored in the database. In such an embodiment of the invention, said generating a commercial offer personalized for the customer can be further based on the one or more customer transaction patterns.

Additionally, at least one embodiment of the invention can include determining merchant context information from a message pertaining to a customer transaction, determining transaction context information from the message pertaining to the customer transaction, and annotating the message with said merchant context information and said transaction context information. Further, such an embodiment can also include applying one or more rules to the annotated message, wherein said one or more rules correspond to one or more conditions associated with a set of commercial offers, and identifying at least one of the set of commercial offers to submit to the customer based on said application of the one or more rules to the annotated message.

In such an embodiment of the invention, merchant context information can include, for example, location of the merchant, a merchant category associated with the merchant, etc. Additionally, transaction context information can include, for example, temporal information associated with the customer transaction.

The techniques depicted in FIG. 5 can also, as described herein, include providing a system, wherein the system includes distinct software modules, each of the distinct software modules being embodied on a tangible computer-readable recordable storage medium. All of the modules (or any subset thereof) can be on the same medium, or each can be on a different medium, for example. The modules can include any or all of the components shown in the figures and/or described herein. In an aspect of the invention, the modules can run, for example, on a hardware processor. The method steps can then be carried out using the distinct software modules of the system, as described above, executing on a hardware processor. Further, a computer program product can include a tangible computer-readable recordable storage medium with code adapted to be executed to carry out at least one method step described herein, including the provision of the system with the distinct software modules.

Additionally, the techniques depicted in FIG. 5 can be implemented via a computer program product that can include computer useable program code that is stored in a computer readable storage medium in a data processing system, and wherein the computer useable program code was downloaded over a network from a remote data processing system. Also, in an aspect of the invention, the computer program product can include computer useable program code that is stored in a computer readable storage medium in a server data processing system, and wherein the computer useable program code is downloaded over a network to a remote data processing system for use in a computer readable storage medium with the remote system.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in a computer readable medium having computer readable program code embodied thereon.

An aspect of the invention or elements thereof can be implemented in the form of an apparatus including a memory and at least one processor that is coupled to the memory and configured to perform exemplary method steps.

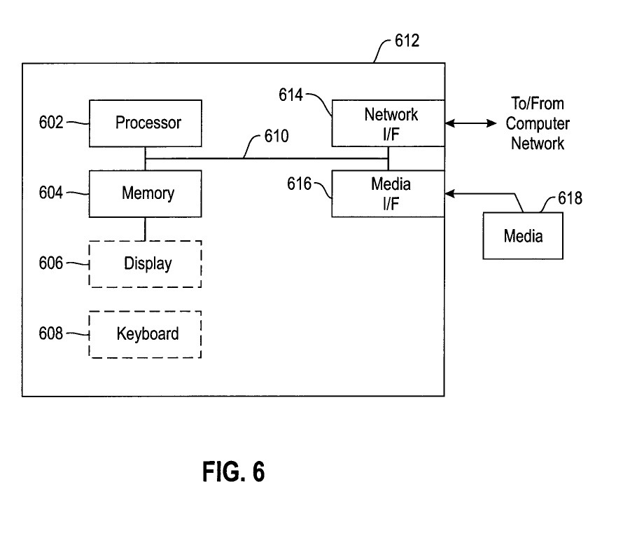

Additionally, an aspect of the present invention can make use of software running on a general purpose computer or workstation. With reference to FIG. 6, such an implementation might employ, for example, a processor 602, a memory 604, and an input/output interface formed, for example, by a display 606 and a keyboard 608. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, a mechanism for inputting data to the processing unit (for example, mouse), and a mechanism for providing results associated with the processing unit (for example, printer). The processor 602, memory 604, and input/output interface such as display 606 and keyboard 608 can be interconnected, for example, via bus 610 as part of a data processing unit 612. Suitable interconnections, for example via bus 610, can also be provided to a network interface 614, such as a network card, which can be provided to interface with a computer network, and to a media interface 616, such as a diskette or CD-ROM drive, which can be provided to interface with media 618.

Accordingly, computer software including instructions or code for performing the methodologies of the invention, as described herein, may be stored in associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 602 coupled directly or indirectly to memory elements 604 through a system bus 610. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including but not limited to keyboards 608, displays 606, pointing devices, and the like) can be coupled to the system either directly (such as via bus 610) or through intervening I/O controllers (omitted for clarity).

Network adapters such as network interface 614 may also be coupled to the system to enable the data processing system to become coupled to other data processing systems or remote printers or storage devices through intervening private or public networks. Modems, cable modems and Ethernet cards are just a few of the currently available types of network adapters.

As used herein, including the claims, a “server” includes a physical data processing system (for example, system 612 as shown in FIG. 6) running a server program. It will be understood that such a physical server may or may not include a display and keyboard.

As noted, aspects of the present invention may take the form of a computer program product embodied in a computer readable medium having computer readable program code embodied thereon. Also, any combination of computer readable media may be utilized. The computer readable medium may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM), flash memory, an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using an appropriate medium, including but not limited to wireless, wireline, optical fiber cable, radio frequency (RF), etc., or any suitable combination of the foregoing.

Computer program code for carrying out operations for aspects of the present invention may be written in any combination of at least one programming language, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. Accordingly, an aspect of the invention includes an article of manufacture tangibly embodying computer readable instructions which, when implemented, cause a computer to carry out a plurality of method steps as described herein.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, component, segment, or portion of code, which comprises at least one executable instruction for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that any of the methods described herein can include an additional step of providing a system comprising distinct software modules embodied on a computer readable storage medium; the modules can include, for example, any or all of the components detailed herein. The method steps can then be carried out using the distinct software modules and/or sub-modules of the system, as described above, executing on a hardware processor 602. Further, a computer program product can include a computer-readable storage medium with code adapted to be implemented to carry out at least one method step described herein, including the provision of the system with the distinct software modules.

In any case, it should be understood that the components illustrated herein may be implemented in various forms of hardware, software, or combinations thereof, for example, application specific integrated circuit(s) (ASICS), functional circuitry, an appropriately programmed general purpose digital computer with associated memory, and the like. Given the teachings of the invention provided herein, one of ordinary skill in the related art will be able to contemplate other implementations of the components of the invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of another feature, integer, step, operation, element, component, and/or group thereof.

The corresponding structures, materials, acts, and equivalents of all means or step plus function elements in the claims below are intended to include any structure, material, or act for performing the function in combination with other claimed elements as specifically claimed.

At least one aspect of the present invention may provide a beneficial effect such as, for example, providing real-time analytics of transaction alerts to customers via SMS.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
generating a profile of a customer, the customer profile comprising multiple commercial-related parameters pertaining to the customer based at least on past transaction information of the customer;
determining the identity of a merchant from a message pertaining to a transaction of the customer;
determining location information of the customer from the message pertaining to the customer transaction; and
generating at least one commercial offer personalized for the customer based on (i) the customer profile, (ii) the merchant identified from the message, and (iii) the customer location determined from the message;
wherein at least one of the steps is carried out by a computing device.

2. The method of claim 1, wherein said message pertaining to the customer transaction comprises a banking message intended for the customer pertaining to the customer transaction.

3. The method of claim 1, wherein said message comprises a short message service (SMS) message.

4. The method of claim 1, wherein each of said steps is carried out in real-time.

5. The method of claim 1, wherein said generating a profile of the customer comprises deriving information pertaining to the customer from one or more social media sources.

6. The method of claim 1, comprising:
determining the location of the merchant from the message pertaining to the customer transaction.

7. The method of claim 6, wherein said generating the at least one commercial offer personalized for the customer is further based on the location of the merchant determined from the message.

8. The method of claim 1, comprising:
determining a merchant category associated with the merchant from the message pertaining to the customer transaction.

9. The method of claim 8, wherein said generating the at least one commercial offer personalized for the customer is further based on the merchant category of the merchant determined from the message.

10. The method of claim 1, comprising:
determining temporal information associated with the customer transaction from the message pertaining to the customer transaction.

11. The method of claim 10, wherein said generating the at least one commercial offer personalized for the customer is further based on the temporal information associated with the customer transaction.

12. The method of claim 1, comprising:
storing the message in a database.

13. The method of claim 12, comprising:
determining one or more customer transaction patterns from information stored in the database.

14. The method of claim 13, wherein said one or more customer transaction patterns comprise frequency of a given transaction type.

15. The method of claim 13, wherein said generating the at least one commercial offer personalized for the customer is further based on the one or more customer transaction patterns.

16. An article of manufacture comprising a computer readable storage medium having computer readable instructions tangibly embodied thereon which, when implemented, cause a computer to carry out a plurality of method steps comprising:
generating a profile of a customer, the customer profile comprising multiple commercial-related parameters pertaining to the customer based at least on past transaction information of the customer;
determining the identity of a merchant from a message pertaining to a transaction of the customer;
determining location information of the customer from the message pertaining to the customer transaction; and
generating at least one commercial offer personalized for the customer based on (i) the customer profile, (ii) the merchant identified from the message, and (iii) the customer location determined from the message.

17. The article of manufacture of claim 16, wherein said message pertaining to a customer transaction comprises a banking message intended for the customer pertaining to the customer transaction.

18. The article of manufacture of claim 16, wherein said message comprises a short message service (SMS) message.

19. The article of manufacture of claim 16, wherein said generating a profile of the customer comprises deriving information pertaining to the customer from one or more social media sources.

20. A system comprising:
a memory; and
at least one processor coupled to the memory and configured for:
generating a profile of a customer, the customer profile comprising multiple commercial-related parameters pertaining to the customer based at least on past transaction information of the customer;
determining the identity of a merchant from a message pertaining to a transaction of the customer;
determining location information of the customer from the message pertaining to the customer transaction; and
generating at least one commercial offer personalized for the customer based on (i) the customer profile, (ii) the merchant identified from the message, and (iii) the customer location determined from the message.

21. A method comprising:
determining merchant context information from a message pertaining to a customer transaction;
determining transaction context information from the message pertaining to the customer transaction;
annotating the message with said merchant context information and said transaction context information;
applying one or more rules to the annotated message, wherein said one or more rules correspond to one or more conditions associated with a set of commercial offers; and
identifying at least one of the set of commercial offers to submit to the customer based on said application of the one or more rules to the annotated message;
wherein at least one of the steps is carried out by a computing device.

22. The method of claim 21, wherein said merchant context information comprises location of the merchant.

23. The method of claim 21, wherein said merchant context information comprises a merchant category associated with the merchant.

24. The method of claim 21, wherein said transaction context information comprises temporal information associated with the customer transaction.
